(19) United States
(12) Patent Application Publication
(10) Pub. No.: US 2026/0303366 A1
(43) Pub. Date: Oct. 1, 2026

(54) OPTIMAL STATELESS DETERMINISTIC THRESHOLD SCHNORR SIGNATURES FROM BI-HOMOMORPHIC PSEUDO-RANDOM FUNCTIONS

(71) Applicant: Circle Internet Group, Inc., Boston, MA (US)

(72) Inventor: Vipin Singh Sehrawat, Fremont, CA (US)

(21) Appl. No.: 19/083,370

(22) Filed: Mar. 18, 2025

(51) Int. Cl. H04L 9/32

(52) U.S. Cl. CPC H04L 9/3255

(57) ABSTRACT

Implementations of the present disclosure can include actions of receiving, by a second computing device and from a first computing device, a first set of nonce values, each nonce value being generated using a first BH-PRF and being deterministic with respect to a message, transmitting, by the second computing device and to the first computing device, a second set of nonce values, each nonce value being generated using a second BH-PRF and being deterministic with respect to the message, and executing, by the second computing device, at least part of a TSS in response to verifying, by the second computing device, correctness of a verification token based on the first set of nonce values and the second BH-PRF, and correctness of the verification token being verified by the first computing device based on the second set of nonce values and the first BH-PRF.

### TECHNICAL FIELD

This specification relates generally to threshold signature schemes for cryptographic signatures using distributed keys for improved security and technical efficiency in cryptographic networks.

### BACKGROUND

Cryptographic networks enable entities (e.g., enterprise, users) to securely exchange electronic communications. For example, cryptographic networks can use public-key cryptography to enable encrypted communications to be exchanged between entities. In general, public-key cryptography uses key-pairs that are generated using a cryptographic algorithm (e.g., using the Advanced Encryption Standard (AES)), each key-pair including a public key and a private key. Each entity is assigned its own key-pair, where the public key is available to one or more other entities and the private key is held confidential to the respective entity.

In securing communications, entities use keys to encrypt information contained in exchanged messages. The information can be encrypted using asymmetric key encryption, which can include a sending entity using the public key of a receiving entity to encrypt information, which can only be decrypted using the private key of the receiving entity. As such, security is achieved through secrecy of the private key of the receiving entity. That is, any entity that has access to the private key of the receiving entity is able to decrypt the information.

To enhance security, techniques such as multi-party computation (MPC) and threshold signature schemes, have been introduced. MPC enables multiple entities to evaluate a computation without revealing any private data held by each entity. A threshold signature scheme (TSS) enables multiple entities to collectively sign messages. That is, a threshold number of entities must participate to generate a valid signature. In TSS, no single entity knows the private key. Instead, each entity knows the public key (shared public key) and holds an individual secret key share that is a share (portion) of the private key (shared private key). In TSS, each entity generates a partial signature and the partial signatures are aggregated to provide a final signature on the intended message. For TSS, distributed key generation (DKG) enables multiple entities to participate in generation of the key-pair. Through DKG, the shared public key is generated, which can be known to all entities, and multiple shares of a private key are generated, each share of the private entity only being known to a respective entity of the multiple entities.

### SUMMARY

This specification describes systems, methods, devices, and other techniques relating to cryptographic signatures using distributed keys for improved security and technical efficiency in cryptographic networks. More particularly, implementations of the present disclosure are directed to deterministic generation of nonce value in cryptographic networks using bi-homomorphic pseudo-random functions (BH-PRFs), the nonce values being used for verification of messages between parties.

In general, innovative aspects of the subject matter described in this specification can include actions of receiving, by a second computing device and from a first computing device, a first set of nonce values, each nonce value in the first set of nonce values being generated using a first BH-PRF of the first computing device and being deterministic with respect to a message, transmitting, by the second computing device and to the first computing device, a second set of nonce values, each nonce value in the second set of nonce values being generated using a second BH-PRF of the second computing device and being deterministic with respect to the message, and executing, by the second computing device, at least part of a threshold signature scheme (TSS) in response to verifying, by the second computing device, correctness of a verification token based on the first set of nonce values and the second BH-PRF, and correctness of the verification token being verified by the first computing device based on the second set of nonce values and the first BH-PRF. Other implementations of this aspect include corresponding systems, apparatus, and computer programs, configured to perform the actions of the methods, encoded on computer storage devices.

These and other implementations can each optionally include one or more of the following features: each nonce value in the first set of nonce values is further generated using a first private key share of the first computing device, and each nonce value in the second set of nonce values is further generated using a second private key share of the second computing device; the first private key share and the second private key share are each used in the TSS to generate respective partial signatures for the message; the first private key share and the second private key share are each generated using a distributed key generation (DKG) protocol; each nonce value in the first set of nonce values and each nonce value in the second set of nonce values is further generated using a shared public key; each nonce value in the first set of nonce values and each nonce value in the second set of nonce values is further generated using a hash of the message; executing, by the second computing device, at least part of a TSS includes generating a partial signature for the message and transmitting the partial signature to the first computing device; the first computing device generates an aggregate signature including the partial signature and at least one other partial signature; the first computing device is operated by a minting entity that mints a cryptocurrency; and the second computing device is operated by a user that trades a cryptocurrency.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual architecture in accordance with implementations of the present disclosure.

FIG. 2 is an example signal flow diagram in accordance with implementations of the present disclosure.

FIG. 3 depicts a flowchart of an example process that can be executed in accordance with implementations of the present disclosure.

Like reference numbers and designations in the various drawings indicate like elements.

### DETAILED DESCRIPTION

This specification describes systems, methods, devices, and other techniques relating to cryptographic signatures using distributed keys for improved security and technical efficiency in cryptographic networks. More particularly, implementations of the present disclosure are directed to deterministic generation of nonce value in cryptographic networks using bi-homomorphic pseudo-random functions (BH-PRFs), the nonce values being used for secure generation of valid signatures.

In some implementations, actions include receiving, by a second computing device and from a first computing device, a first set of nonce values, each nonce value in the first set of nonce values being generated using a first BH-PRF of the first computing device and being deterministic with respect to a message, transmitting, by the second computing device and to the first computing device, a second set of nonce values, each nonce value in the second set of nonce values being generated using a second BH-PRF of the second computing device and being deterministic with respect to the message, and executing, by the second computing device, at least part of a threshold signature scheme (TSS) in response to verifying, by the second computing device, correctness of a verification token based on the first set of nonce values and the second BH-PRF, and correctness of the verification token being verified by the first computing device based on the second set of nonce values and the first BH-PRF.

To provide context for the subject matter of the present disclosure, and as introduced above, cryptographic networks enable entities (e.g., enterprise, users) to securely exchange electronic communications. For example, cryptographic networks can use public-key cryptography to enable encrypted communications to be exchanged between entities. In general, public-key cryptography uses key-pairs that are generated using a cryptographic algorithm (e.g., a key derivation function (KDF)), each key-pair including a public key and a private key. Each entity is assigned its own key-pair, where the public key is available to one or more other entities and the private key is held confidential to the respective entity.

In securing communications, entities use keys to encrypt information contained in exchanged messages. The information can be encrypted using asymmetric key encryption, which can include a sending entity using the public key of a receiving entity to encrypt information, which can only be decrypted using the private key of the receiving entity. As such, security is achieved through secrecy of the private key of the receiving entity. That is, any entity that has access to the private key of the receiving entity is able to decrypt the information.

To enhance security, techniques such as multi-party computation (MPC) and threshold signature schemes (TSSs), have been introduced. MPC enables multiple entities to evaluate a computation without revealing any private data held by each entity. A TSS enables multiple entities to collectively sign a message. That is, a threshold number of entities must participate to generate a valid signature. Typical approaches use a 2-out-of-n threshold, meaning that at least two of n>2 are needed to participate. In TSS, no single entity knows the private key. Instead, each entity knows the public key (shared public key) and holds an individual secret key share that is a share (portion) of the private key (shared private key). In TSS, each entity generates a partial signature and the partial signatures are aggregated to provide a final signature on the intended message. For TSS, distributed key generation (DKG) enables multiple entities to participate in generation of the key-pair. Through DKG, the shared public key is generated, which can be known to all entities, and multiple shares of a private key, referred to as private key shares, are generated, each private key share only being known to a respective entity of the multiple entities.

It is an established practice in cryptographic networks to realize threshold Edwards-curve Digital Signature Algorithm (EdDSA) signatures using threshold Schnorr signatures. In this context, EdDSA can be described as a digital signature scheme using a deterministic variant of Schnorr signature based on twisted Edwards curves and is intended to be more computationally efficient than other digital signature schemes without sacrificing security.

To provide further context for implementations of the present disclosure, a discussion of motivations for user of threshold EdDSA signatures is provided. In threshold Schnorr, parties can collaboratively generate random nonces without relying on a central trusted party. However, using threshold EdDSA signatures, each nonce is derived deterministically from the private key and the message. This deterministic process makes it more challenging to distribute the computation among multiple parties without compromising security. Generating the nonce deterministically across multiple parties requires securely sharing and managing the key material and hash function outputs, which increases the protocol complexity and attack surface, and significantly impacts its efficiency. Further, Schnorr signatures are linear in nature and perform a linear combination of the randomness and the private key, making it naturally suited for threshold settings. This is because each party generates a share of the signature and the shares are linearly combined to produce the final signature. However, use of threshold EdDSA signatures introduces non-linearities due to the deterministic nonce generation and hash function usage. Due to its simpler structure and linearity, threshold Schnorr is more efficient in terms of computation and communication overhead. This is as compared to threshold EdDSA signatures, which, while optimized for individual use cases (due to smaller key sizes and faster signature generation), introduce significant complexities in threshold settings, leading to much higher computational and communication costs.

One approach to implement threshold Schnorr signatures is the Flexible Round-Optimized Schnorr Threshold Signatures (FROST) protocol, which is detailed in FROST: Flexible Round-Optimized Schnorr Threshold Signatures, Komlo et al., Dec. 22, 2020, which is incorporated herein by reference. However, FROST, like all other threshold Schnorr protocols, mandates random nonces and forbids reusing nonces between different signatures. This is because reuse of nonces leads to leakage of the private key and breaks the security. Since reusing nonces is forbidden, threshold Schnorr signatures are always stateful. That is, each party must retain state between rounds and securely delete afterward. In large-scale, concurrent signing, managing this state can become a major performance bottleneck, and securely handling secret state poses a security risk. For example, cryptographic networks include computational (and storage) nodes and/or user devices, any of which can go offline unpredictably, and signing occurs concurrently at scale. This makes secure management of secret states difficult. Hence, for secure, large-scale implementation of threshold Schnorr signatures, it is highly desirable to have efficient stateless deterministic threshold Schnorr signatures.

This problem has been a focus of active research and there are multiple approaches to address the problem. One example approach includes a stateless deterministic threshold Schnorr based on zero-knowledge from garbled circuits. However, this is computationally inefficient and incurs heavy (in terms of technical resources expended) additional communication between parties. Another example approach includes stateless deterministic threshold Schnorr based on pseudorandom correlation functions. This approach, however, also incurs heavy computational and communication overheads. Still another example approach includes a stateless deterministic threshold Schnorr based on verifiable pseudorandom secret sharing. While this approach is more efficient than the other example approaches, it is still very computationally inefficient. Further, it cannot support 2-out-of-2 signing and requires an honest majority. The closest that it can achieve is 3-out-of-3 signing with, at most, one malicious party. This is not a plausible assumption for large-scale cryptographic networks.

Accordingly, it can be stated that, while efficient and deterministic multi-party Schnorr signature schemes are desirable, known approaches have significant drawbacks in implementation. For example, the difficulty arises because, while honest parties can deterministically choose their nonces (e.g., by hashing their secret signing share and the message), a malicious party could instead pick its nonce randomly. In Schnorr signatures, the signature σ=(R, z) involves a commitment R and a response z, satisfying the equation g^{z}=R·K^{c}, where K is the public key and c=H(R, K, M) is the challenge based on R, K, and the message M. In threshold Schnorr signatures, where both R and z are contributed by all parties, if one party deviates from the protocol, the challenge c can change. Without a way for honest parties to verify compliance, this deviation enables a key recovery attack with just two signing queries.

Hence, the following properties must be satisfied:
1. The deterministic manner in which the message, public key, and/or any other public information was used to generate the nonce must be verifiable by the other parties.
2. The deterministic nonce can only be performed by the intended party.
3. Additional, dedicated communication rounds should not be required.
4. Two-party transactions should be supported.

In view of the foregoing, implementations of the present disclosure provide for deterministic generation of nonce values in cryptographic networks using BH-PRFs, the nonce values being used for verification of messages between parties. As described in further detail herein, implementations of the present disclosure enable secure implementation of deterministic threshold Schnorr between parties in 2-out-of-2 TSS settings, while providing computational efficiencies over known approaches aimed at realizing the same goal.

Implementations of the present disclosure are described in further detail with non-limiting reference to an example use case. The example use case includes a cryptographic network that enables generation and storage of, and transactions related to digital assets, such as cryptocurrencies. For example, a cryptocurrency network can enable creation of tokens of a cryptocurrency that can be transferred between entities through transactions. In such cryptocurrency networks, transactions (e.g., creation, transfer) are immutably recorded in a distributed ledger, commonly referred to as a blockchain. While cryptocurrency networks are referenced herein, it is contemplated that implementations of the present disclosure can be realized for any appropriate cryptographic network for any appropriate use case.

With regard to cryptocurrency networks, users (entities) can hold digital assets as stores of value and mediums of exchange. In general, a digital asset can be described as a virtual store of value that leverages a peer-to-peer network to store, record, and validate transactions. A provider (entity) of the digital asset generates (which can be referred to as minting) tokens of the digital asset. The peer-to-peer network can maintain a distributed ledger (e.g., blockchain), which can be described as a decentralized database that immutably stores transactions across the peer-to-peer network. Example digital assets can include, without limitation, cryptocurrencies (e.g., stablecoins), non-fungible tokens (NFTs), security tokens, tokenized money market funds (T-MMF), and the like (e.g., government obligations).

Implementations of the present disclosure are described in further detail with non-limiting reference to cryptocurrency, among other digital assets. In some examples, a cryptocurrency can be described as a digital currency that uses cryptography to secure transactions that are recorded in the distributed ledger (e.g., blockchain). In some examples, a digital token (also referred to as a token) can be described as immutable, computer-readable code that represents an increment of a digital asset and is stored in the distributed ledger.

Implementations of the present disclosure are described in further detail herein with reference to example peer-to-peer networks (also referred to herein as chain networks and/or cryptocurrency networks), each maintaining a respective chain (distributed ledger, blockchain). Some example peer-to-peer networks can each be described as an Ethereum-compatible network. Ethereum can be described as a decentralized computing infrastructure that executes a virtual machine, referred to as the Ethereum virtual machine (EVM), to execute transactions on a chain. The EVM can be described as a global singleton and operates as a single-instance computer, globally across nodes of the peer-to-peer network. That is, each node in the network executes a local copy of the EVM to execute transactions on the chain. The chain of the peer-to-peer network records the changing state of the EVM as transactions are processed. While Ethereum is referenced herein for purposes of illustration, it is contemplated that implementations of the present disclosure can be realized using any appropriate peer-to-peer network (e.g., networks that provide on-chain computing; EVM-compatible chains). Example peer-to-peer networks can include, without limitation, Arbitrum, Avalanche, and Base, among several others, each of which is EVM-compatible. It is contemplated, however, that implementations of the present disclosure can be realized in peer-to-peer networks that are not EVM-compatible.

In general, tokens of a digital asset can be generated using a minting process. Minting can generally be described as generating tokens of a digital asset through execution of cryptographic transactions within a network and recording the transactions in a blockchain maintained within the network. In some examples, minting is executed through a minting function of a smart contract (minter) that is executed within the network. On the other hand, tokens of a cryptocurrency can be permanently removed from circulation within a network using a burning process. Burning can generally be described as permanently removing tokens of a cryptocurrency from circulation through execution of cryptographic transactions within a network and recording the transactions in a blockchain maintained within the network. In some examples, burning is executed through a burning function of a smart contract (burner) that is executed within the network. Smart contracts can be described as programs that are executed on-chain and are each provided as a collection of code (functions) and data (state) that resides at a specific address on the chain.

In some instances, a user (entity) can create an account with a provider of a cryptocurrency (e.g., an entity that mints tokens of a cryptocurrency). For example, the user can create an account with the provider of the cryptocurrency to enable the user to purchase tokens of the cryptocurrency. In some examples, creation of the account entails the generation of a key-pair that is used to cryptographically sign transactions within the cryptocurrency network. In some examples, the private key of the user is stored within a wallet of the user that is provisioned on a device of the user. For example, the private key, or the wallet itself, can be stored within a trusted execution environment (TEE) of the device. In the context of TSS, a private key share is generated for the user by the TEE and is stored within the TEE. Further in the context of TSS, a private key share is generated for the minting entity by a TEE of a device (e.g., server) and is stored within the TEE of that device.

Before further detailing implementations of the present disclosure, definitions are provided for context and ease of understanding.

Learning with Errors (LWE) can be considered and can be described as recovering a secret s given a sequence of approximate random linear equations on the secret. LWE is known to be difficult to achieve based on certain assumptions regarding the worst-case hardness of standard lattice problems, such as gap shortest vector problem (SVP) (GapSVP) and Shortest Independent Vectors Problem (SIVP). The following first definition (Decision-LWE) can be provided as, for positive integers n and q, such that q=q(n)≥2, and an error distribution X=X⁽ⁿ⁾ over [symbol] _{q}, the decision-LWE_{n,q,x} problem is to distinguish between the following pairs of distributions:

$$( A , {A}^{T} s + e ) and ( A , u )$$

where m=poly(n),

$$A {←}^{\$} {ℤ}_{q}^{n \times m} , s {←}^{\$} {ℤ}_{q}^{n} , e {←}^{\$} {χ}^{m} , and u {←}^{\$} {ℤ}_{q}^{m} .$$

The following second definition (Search-LWE) can be provided as, for positive integers n and q, such that q=q(n)≥2, and an error distribution X=X⁽ⁿ⁾ over [symbol] _{q}, the search-LWE_{n,q,x} problem is to recover s ∈

$${ℤ}_{q}^{n} ,$$

given m(=(n)) independent samples of (A, A^{T}s+e), where

$$A {←}^{\$} {ℤ}_{q}^{n \times m} , s {←}^{\$} {ℤ}_{q}^{n} , and e {←}^{\$} {χ}^{m} .$$

In contrast, Learning with Rounding (LWR) can be described as, instead of adding a random small error as done in LWE, a deterministically rounded version of the sample is released. In particular, for some p<q, the elements of [symbol] _{q} are divided into p contiguous intervals of roughly q/p elements each. A rounding function is defined as [·]ₚ: [symbol] _{q}→ [symbol] , and maps x∈ [symbol] into the index of the interval that x belongs to. The LWR problem was shown to be as difficult as LWE for a setting of parameters where the modulus and modulus-to-error ratio are super-polynomial.

A pseudorandom function (PRF) can be generally described as a function that can be used to generate output from a random seed and a data variable, such that the output is computationally indistinguishable from truly random output. A PRF F: [symbol] ×X→ [symbol] is key-homomorphic (i.e., is a key-homomorphic PRF (KH-PRF), if the key-space ( [symbol] ,⊕) and the range ( [symbol] ,⊕) exhibit group structures, where, for any two keys k₁, k₂ and input x∈X, F(k₁(k₂, x)=F(k₁, x)⊕F(k₂, x).

Building on this, a LWE-based KH-PRF can be constructed to achieve ‘almost homomorphism’ that can be defined using a third definition—Let a

$$PRF F : 𝒦 \times 𝒳 \to {ℤ}_{p}^{m}$$

be an efficiently computable function such that ( [symbol] ,⊕) is a group. The tuple (F,⊕) is a γ-almost key homomorphic PRF if the following two properties hold:
1. F is a secure PRF.
2. For every k₁, k₂ ∈ [symbol] and every x∈X, there exists a vector e∈[0,γ]^{m} such that

$$F ( {k}_{1} , x ) + F ( {k}_{2} , x ) = F ( {k}_{1} ⊕ {k}_{2} , x ) + e mod p .$$

Standard-model constructions of KH-PRFs can be provided using lattices/LWE, which prove the KH-PRF to be secure under the n-dimensional LWE assumption, for error rates α=n^{-Ω(l)}. Other KH-PRFs have been provided from substantially weaker LWE assumptions (e.g., error rates of only α=n^{-Ω(logl)}) which yields better key sizes and runtimes.

For further definitions, the following notations are introduced:

$$x = {x}_{ℓ} ‖ {x}_{r} , where 1 \leq \vert {x}_{ℓ} \vert \leq ⌊ \vert x \vert / 2 ⌋ and \vert {x}_{r} \vert = \vert x \vert - \vert {x}_{ℓ} \vert$$

$${x}_{a} = {x}_{a . ℓ} ‖ {x}_{a . r} , where 1 \leq \vert {x}_{a . ℓ} \vert \leq ⌊ \vert {x}_{a} \vert / 2 ⌋ and \vert {x}_{a . r} \vert = \vert {x}_{a} \vert - \vert {x}_{a . ℓ} \vert$$

Continuing, the following fourth definition can be provided—Let

$$F : 𝒦 \times 𝒳 \to {ℤ}_{p}^{m \times m}$$

be a PRF family, such that (K,⊕) and (X,⊕) are groups. It can be said that the tuple (F,⊖,⊕) is a γ-almost fully key and partially input homomorphic PRF if one of the following conditions holds:

1. For every k₁, k₂ ∈K, and x₁, x₂ ∈X, such that [symbol] = [symbol] = [symbol] , there exists a vector E∈[0, γ]^{m×m} such that:

$$F ( {k}_{1} , {x}_{1} ) + F ( {k}_{2} , {x}_{2} ) + E = F ( {k}_{1} ⊕ {k}_{2} , x ) mod p ,$$

where x=( [symbol] ⊖, [symbol] ).

2. For every k₁, k₂ ∈K, and x₁, x₂ ∈X, such that [symbol] = [symbol] = [symbol] , there exists a vector E∈[0, γ]^{m×m} such that:

$$F ( {k}_{1} , {x}_{1} ) + F ( {k}_{2} , {x}_{2} ) + E = F ( {k}_{1} ⊕ {k}_{2} , x ) mod p ,$$

where x=xₗ∥(x_{1.r}⊖x_{2.r})∥x₇.

The following fifth defintion is provided—Let X [symbol] , with ⊖ defining the surjective mapping:

$$𝒳 ⊖ 𝒳 \to 𝒴 \cdot Let F : 𝒦 \times 𝒳 \to {ℤ}_{p}^{m \times m} and {F}^{′} : 𝒦 \times 𝒴 \to {ℤ}_{p}^{m \times m}$$

two PRF families, where (K,⊕) is a group. It can be said that the tuple (F,⊖,⊕) is a γ-almost fully key and partially input homomorphic PRF with homomorphically induced variable input length, if one of the following conditions holds:

1. For every k₁, k₂ ∈ [symbol] , and x₁, x₂ ∈X, such that [symbol] = [symbol] ( [symbol] ), there exists a vector E∈[0, γ]^{m×m} such that:

$$F ( {k}_{1} , {x}_{1} ) + F ( {k}_{2} , {x}_{2} ) + E = {F}^{′} ( {k}_{1} ⊕ {k}_{2} , y ) mod p ,$$

where y∈ [symbol] , such that y= [symbol] ∥yᵣ, with [symbol] = [symbol] and yᵣ=(x_{1.r} x_{2.r}).

2. For every k₁, k₂ ∈ [symbol] , and x₁, x₂ ∈X, such that x₁.r=x_{2.r}=xᵣ, there exists a vector E∈[0, γ]^{m×m} such that:

$$F ( {k}_{1} , {x}_{1} ) + F ( {k}_{2} , {x}_{2} ) + E = {F}^{′} ( {k}_{1} ⊕ {k}_{2} , y ) mod p ,$$

where y∈ [symbol] , such that y= [symbol] ∥yᵣ, with yᵣ=xᵣ and [symbol] =( [symbol] ⊖ [symbol] ).

The following sixth definition is provided—Let [symbol] ⊂X ⊂ [symbol] , with ⊖ defining the surjective mapping:

$$𝒳 ⊖ 𝒳 \to 𝒴 \cdot Let F : 𝒦 \times 𝒳 \to {ℤ}_{p}^{m \times m} and {F}^{′} : 𝒦 \times 𝒴 \to {ℤ}_{p}^{m \times m}$$

be two PRF families, where ( [symbol] ,⊕) is a group. It can be said that the tuple (F,⊖, ⊕) is a left KH constrained-PRF with homomorphically induced variable input length, if for any k₀∈ [symbol] and a fixed w∈ [symbol] , given Fₖ_{₀}(w∥·)∈ [symbol] , there exists an efficient algorithm to compute F′ₖ_{_{0⊕k}}₁(w, y)∈ [symbol] , for all k₁∈ [symbol] and y∈ [symbol] . Similarly, it can be said that the tuple (F,⊖,⊕) is a right KH constrained-PRF with homomorphically induced variable input length, if given Fₖ_{₀} (·∥w)∈ [symbol] , there exists an efficient algorithm to compute [symbol] ₖ_{₀}_{⊕k}_{₁}(y, w)∈ [symbol] , for all k₁∈ [symbol] and y∈ [symbol] .

For the sake of clarity, it can be noted that KH constrained-PRFs with homomorphically induced variable input length are referred to herein as bi-homomorphic PRFs.

For constructing a bi-homomorphic PRF family, a rounding function is provided using a security parameter λ. More particularly, the rounding function has form [·]: [symbol] → [symbol] where q≥p≥2, and can be provided as:

$${⌊ x ⌉}_{p} = ⌊ \frac{p}{q} \cdot x ⌉$$

Here, if [x]ₚ=i, then i·[q/p] is the integer multiple of [q/p] that is nearest to x. So, x is deterministically rounded to the nearest element of a sufficiently “coarse” public subset of p<<q, well-separated values in [symbol] (e.g., a subgroup). Thus, the “error term” comes solely from deterministically rounding x to a relatively nearby value in [symbol] . As discussed herein, the problem of distinguishing such rounded products from uniform samples is called the decision-learning with rounding (LW R_{n,g,p}) problem. The rounding function is extended component wise to vectors and matrices over [symbol] .

Continuing, let l=[log q] and d=l+1, and a gadget vector can be provided as:

$$g = ( 0 , 1 , 2 , 4 , ... , {2}^{l - 1} ) ∈ {ℤ}_{q}^{d}$$

A deterministic decomposition function can be provided g⁻¹: [symbol] →{0,1}^{d}, such that g⁻¹ (a) is a “short” vector and ∇a∈ [symbol] _{q}. It holds that: [symbol] g, g⁻¹(a))=a, where [symbol] · [symbol] denotes the inner product. The function g⁻¹ is provided as:

$${g}^{- 1} ( a ) = ( {x}^{′} , {x}_{0} , {x}_{1} , ... , {x}_{l - 1} ) ∈ {\{ 0 , 1 \}}^{d}$$

where x′=0, and

$$a = {\sum }_{i = 0}^{l - 1} {x}_{i} {2}^{i}$$

is the binary representation of a. The gadget vector is used to define the gadget matrix G as:

$$G = {I}_{n} ⊗ g = diag ( g , ... , g ) ∈ {ℤ}_{q}^{n \times nd}$$

where Iₙ is the n×n identity matrix and ⊗ denotes the Kronecker product. The binary decomposition function, g⁻¹, is applied entry-wise to vectors and matrices over [symbol] _{q}. Thus, g⁻¹ is extended to get another deterministic decomposition function

$${G}^{- 1} : {ℤ}_{q}^{n \times m} \to {\{ 0 , 1 \}}^{nd \times m} ,$$

such that, G·G⁻¹(A)=A. The addition operations inside the binary decomposition functions g⁻¹ and G⁻¹ are performed as integer operations (over all integers [symbol] ), and not done in [symbol] _{q}.

The following notation is provided:

$${x}_{ℓ h} : left half of x , such that \vert {x}_{ℓ h} \vert - ⌊ \vert x / 2 \vert ⌋$$

$${x}_{rh} : right half of x , such that \vert {x}_{rh} \vert - ⌈ \vert x / 2 \vert ⌉$$

$$x [ i ] : the {i}^{th} bit of x$$

Continuing, T is provided as a full binary tree with at least one node, with T.r and T. [symbol] denoting its right subtree and left subtree, respectively. For random matrices

$${A}_{0} , {A}_{1} ∈ {ℤ}_{q}^{n \times n d} ,$$

a function

$${A}_{T} : {\{ 0 , 1 \}}^{\vert T \vert} \to {ℤ}_{q}^{n \times n d}$$

can be recursively defined as:

$${A}_{T} ( x ) = \{ \begin{matrix}{A}_{x} & if \vert T \vert = 1 \\ {A}_{T \cdot ℓ} ( {x}_{ℓ} ) + {A}_{x [ 0 ]} {G}^{- 1} ( {A}_{T \cdot r} ( {x}_{r} ) ) & otherwise\end{matrix}$$

where x= [symbol] ∥xᵣ, [symbol] ∈{0,1} [symbol] , xᵣ∈{0,1}^{|T.r|}, and |T| denotes the number of leaves in T. Based on the random seed.

$$S ∈ {ℤ}_{q}^{n \times n d} ,$$

the BH-PRF family, [symbol] _{(A}_{₀}_{,A}_{₁}_{,Tp)}, is defined as:

$${ℱ}_{( {A}_{0} , {A}_{1} , T , p )} = \{ FS : {\{ 0 , 1 \}}^{2 \vert T \vert} \to {ℤ}_{p}^{n d \times n d} \}$$

Seed-dependent matrices,

$${B}_{0} , {B}_{1} ∈ {ℤ}_{q}^{n \times n d} ,$$

can be defined as:

$${B}_{0} = {A}_{0} + S$$

$${B}_{1} = {A}_{1} + S$$

Using the seed dependent matrices, a function

$${B}_{T}^{S} ( x )$$

is defined recursively as:

$${B}_{T}^{S} ( x ) = \{ \begin{matrix}{B}_{x} & if \vert T \vert = 1 \\ {B}_{T \cdot ℓ}^{S} ( {x}_{ℓ} ) + {A}_{x [ 0 ]} {G}^{- 1} ( {B}_{T \cdot r}^{S} ( {x}_{r} ) ) & otherwise\end{matrix}$$

Continuing,

$$R : {\{ 0 , 1 \}}^{\vert T \vert} \to {ℤ}_{q}^{nd \times n}$$

is provided as a pseudorandom generator, and y= [symbol] ∥yᵣₕ, where [symbol] , yᵣₕ∈ {0,1}^{|T|}. In order to keep the length of the equations in check, the product R( [symbol] ). A_{y|0|} is represented by the notation: R₀( [symbol] ). A member of the BH-PRF family is indexed by the seed S as:

$${{F}_{S} ( y ) := ⌊ {S}^{T} \cdot {A}_{T} ( {y}_{ℓ h} ) + {R}_{0} ( {y}_{ℓ h} ) \cdot {G}^{- 1} ( {B}_{T}^{S} ( {y}_{rh} ) ) ⌉}_{p}$$

Let 0=00, i.e., it represents two consecutive 0 bits. The following function family can be defined:

$${{ℱ}^{′}}_{( 𝔸 , T , p )} = \{ {F}_{S}^{′} : {\{ 0 , 1 \}}^{\vert T \vert} \times {\{ 0 , 1 , \overline{0} \}}^{\vert T \vert} \to {ℤ}_{p}^{n d \times n d} \}$$

where A={A₀, A₁, B₀, B₁, C₀, C₁, C̅₀̅}, and the matrices C₁, C₀, C̅₀̅ are defined by the seed

$$S ∈ {ℤ}_{q}^{n \times nd}$$

as:

$${C}_{1} = {A}_{0} + {B}_{1} ; {\overline{C}}_{0} = {A}_{0} + {B}_{0} ; {C}_{0} = {A}_{1} + {B}_{1}$$

A function

$${C}_{T} : {\{ 0 , 1 \}}^{\vert T \vert} \times {\{ 0 , 1 , \overline{0} \}}^{\vert T \vert} \to {ℤ}_{q}^{n \times n d}$$

can be recursively defined as:

$${C}_{T}^{S} ( x ) = \{ \begin{matrix}{C}_{x} & if \vert T \vert = 1 \\ {C}_{0} & if \vert T \vert > 1 ∧ x [ i ] = x [ i + 1 ] = 0 \\ {C}_{T . ℓ}^{S} ( {x}_{ℓ} ) + {A}_{x [ 0 ]} {G}^{- 1} ( {C}_{T . r}^{S} ( {x}_{r} ) ) & otherwise\end{matrix} ,$$

Here, C̅₀̅ denotes two bits. Hence, during the evaluation of C S_{T}(x), a leaf in T may represent one bit or two bits. Let z=z₀∥z₁, where z₀∈{0,1}^{|T|} and z₁∈{0,1, 0̅}^{|T|}. A member of the function family [symbol] can be defined as:

$${{F}_{S}^{′} ( {z}_{0} , {z}_{1} ) := ⌊ {S}^{T} \cdot {A}_{T} ( {z}_{0} ) + {R}_{0} ( {z}_{0} ) \cdot {G}^{- 1} ( {C}_{T}^{S} ( {z}_{1} ) ) ⌉}_{p}$$

where R₀(z₀)=R(z₀). A_{z}_{₀}_{[0]}. Here, a bulk of the computation performed while evaluating the PRFs, Fₛ(x) and F'ₛ(x₀, x₁), is in computing the functions

$${A}_{T} ( x ) , {B}_{T}^{S} ( x ) , {C}_{T}^{S} ( x ) .$$

While computing these functions on an input x, if all the intermediate matrices are saved, then A_{T}(x′),

Continuing,

$${B}_{T}^{S} ( {x}^{′} ) , {C}_{T}^{S} ( {x}^{′} )$$

can be incrementally computed for a x′ that differs from x in a single bit. Specifically, one only needs to recompute the matrices for those internal nodes of T that appear on the path from the leaf representing the changed bit to the root. Hence, saving the intermediate matrices, that are generated while evaluating the functions on an input x, can significantly speed up successive evaluations on the related inputs x′.

Accordingly, it can be shown that, for any inputs x, y∈{0,1}^{|T| and a full binary tree |T| such that: x}ₗₕ=yₗₕ=z₀ and xᵣₕ ⊕̅yᵣₕ=z₁, where z₀∈{0,1}^{|T|, and z}₁∈{0,1, 0̅}^{|T|, the following holds:}

$${F}_{( {S}_{1} + {S}_{2} )}^{′} ( {z}_{0} , {z}_{1} ) = {F}_{{S}_{1}} ( x ) + {F}_{{S}_{2}} ( y ) + E$$

where ∥E∥≤1.

With the above context, definitions, and notations, and as introduced above, implementations of the present disclosure provide for deterministic generation of nonce values in cryptographic networks using BH-PRFs, the nonce values being used for verification of messages between parties.

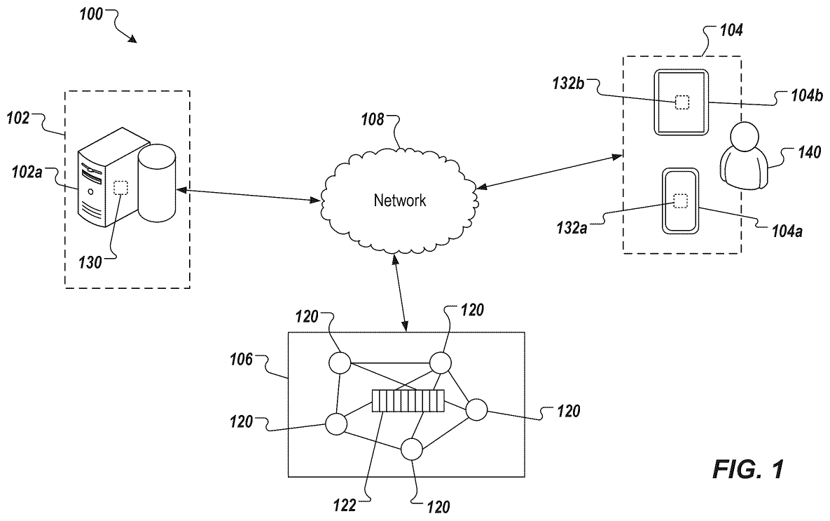

FIG. 1 depicts an example environment 100 that can be used to execute implementations of the present disclosure. In some examples, the example environment 100 enables entities to participate in a cryptographic network for secure communications. The example environment 100 includes a provider system 102, a user system 104, a cryptographic network 106, and a network 108. In some examples, the network 108 includes a local area network (LAN), wide area network (WAN), the Internet, or a combination thereof, and connects web sites, user devices (e.g., computing devices), and back-end systems. In some examples, the network 108 can be accessed over a wired and/or a wireless communications link.

In the example use case, the cryptographic network 106 can be provided as a cryptocurrency network that enables a provider of a cryptocurrency (referred to herein as a minting entity) to distribute tokens of a cryptocurrency to users and that enables users to execute transactions related to the cryptocurrency. The cryptographic network 106 can be described as a peer-to-peer network of nodes 120 and transactions related to the cryptocurrency are immutably stored within a blockchain 122. For example, the blockchain 122 is a distributed ledger that is updated and stored across multiple nodes within the cryptographic network 106. Although the cryptographic network 106 is depicted separately from the network 108, it is contemplated that at least a portion of the cryptographic network 106 can be provided within the network 108 (e.g., as nodes that are distributed across the Internet).

In the depicted example, the provider system 102 includes a computing device 102a, which can, for example, represent one or more servers. In some examples, the computing device 102a is operated by a minting entity to mint tokens of a cryptocurrency and distribute tokens to users, as well as execute transactions. Actions executed by the minting entity are recorded in the blockchain 122 of the cryptographic network 106. In some examples, the computing device 102a can function as a node of the cryptographic network 106. In the example of FIG. 1, the computing device 102a includes a TEE 130.

In the depicted example, the user system 104 includes computing devices 104a, 104b. In some examples, the computing devices 104a, 104b can include, without limitation, a server, a desktop computer, a laptop computer, a tablet computing device, and a smartphone. In the example of FIG. 1, the computing device 104a includes a TEE 132a and the computing device 104b includes a TEE 132b. In some implementations, a user 140 uses the device 104a to execute transactions within the cryptographic network 106, which transactions are immutably recorded in the blockchain 120 of the cryptographic network 106. Example transactions can include, without limitation, purchasing tokens of a cryptocurrency from the minting entity and transferring tokens of cryptocurrency with other users and/or the minting entity. In some examples, the device 104b can also be used to by the user 140 (e.g., multi-device support) to execute transactions.

In further detail and in accordance with implementations of the present disclosure, a TSS can be used to enable the user 140 to execute transactions within the cryptographic network 106. For TSS, an access structure Γ can be defined. For example, a set of parties can be denoted as [symbol] ={P₁, . . . , [symbol] }, where a collection Γ⊆ [symbol] is monotone if [symbol] ∈Γ and [symbol] ∈ [symbol] imply that [symbol] ∈Γ. The access structure, provided as Γ∈ [symbol] , is a monotone collection of non-empty subsets of P. Sets in Γ are called authorized to participate in cryptographic transactions and sets not in Γ are called unauthorized to participate in cryptographic transactions. If Γ consists of all subsets of [symbol] with size greater than or equal to a fixed threshold t(1≤t≤ [symbol] ), then Γ is called a t-threshold access structure. For the access structure Γ, a family of minimal authorized subsets Γ₀∈Γ is defined as:

$${Γ}_{0} = \{ 𝒜 ∈ Γ : ℬ ⊂ 𝒜 for all ℬ ∈ Γ \backslash \{ 𝒜 \} \}$$

Hence, the family of minimal access subsets Γ₀ uniquely determines the access structure Γ, and it holds that Γ=cl(Γ₀), where cl denotes closure.

As introduced above, in a two-party TSS two parties each hold a private key share of a secret private key (e.g., for a cryptocurrency wallet). In the example of FIG. 1, a private key share can be held in the computing device 102a for the minting entity and a private key share can be held in the computing device 104a for the user 140. The security of the system relies on the fact that neither party can sign transactions independently. However, leakage of private key shares is a central threat.

To inhibit such leakage, implementations of the present disclosure provide for deterministic nonce generation and verification that satisfy the requirements discussed herein, which enable the realization of stateless deterministic threshold Schnorr signatures. In accordance with the requirements discussed herein, implementations of the present disclosure support the two-party setting that includes a firsty party P₁ and a second party P₂ with private key shares k₁ and k₂, respectively, that are generated by a secure DKG protocol. An example DKG protocol is described in FROST. Another example DKG protocol is described in commonly assigned U.S. application Ser. No. 18/913,269, filed on Oct. 11, 2024, and entitled Distributed Key Generation and Resharing for Multi-Device Cryptocurrency Wallets with TEE-backed Security, the disclosure of which is expressly incorporated herein by referene in the entirety for all purposes. It is contemplated, however, that implementations of the present disclosure can be realized using any appropriate DKG protocol.

In general, the DKG protocol includes a prime q, an elliptic curve E( [symbol] ), and a cyclic subgroup [symbol] ∈E( [symbol] ) of prime order p, where K₁=K₁G and K₂=k₂G, with G∈ [symbol] being the generator/base point for the cyclic subgroup [symbol] , and k₁, k₂ ∈ [symbol] . Here, Y∈ [symbol] is the public key (i.e., Y=K₁+K₂), m is a message that the firsty party P₁ and the second party P₂ will collectively sign (e.g., the first party P₁ can be a singature aggregator that aggregates partial signatures), H: {0,1}*→{0,1}^{|T|} is a cryptographic hash function, and 1 and 0 denote 1-vector and 0-vector (resp.) of dimension |T|. Further, [symbol] and [symbol] are the function families described above.

For any point P=(xₚ, yₚ)∈ [symbol] , where xₚ, yₚ∈ [symbol] , the binary representation of P is denoted as bitstring (P) and defined as:

$$bitstring ( P ) = bin ( {x}_{P} ) ‖ bin ( {y}_{P} )$$

where bin(xₚ) and bin(yₚ) denote the binary representations of xₚ and yₚ, respectively, each of length [log₂q] bits, and ∥ denotes concatenation. It can also be noted that |T|= [log₂q]. In some examples, a compressed representation can be provided, which results in:

$$bitstring ( P ) = bin ( {b}_{sign} ) ‖ bin ( {x}_{P} )$$

where b_{sign} encodes the necessary information about the yₚ-coordinate (e.g., its parity).

In general, DKG protocols require sending a non-interactive zero-knowledge (NIZK) proof for the knowledge k; and/or its consistency with Kᵢ. This means that, after generating kᵢ, there are additional rounds of communication in every DKG protocol. These additional rounds are dedicated to behavior verification in malicious settings.

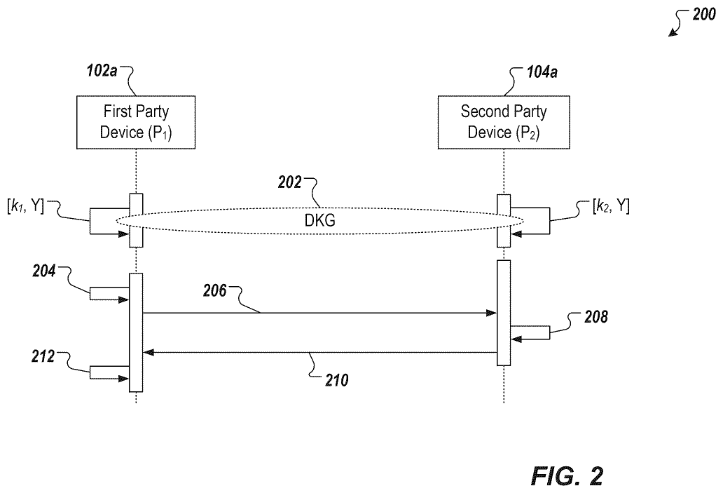

Implementations of the signature and verification protocol of the present disclosure are described in further detail herein with reference to FIG. 2, which is an example signal flow diagram 200 in accordance with implementations of the present disclosure. In the example of FIG. 2, the computing device 102a is provided as a first party P₁ and the computing device 104a is provided as a second party P₂. In the example context of cryptocurrency introduced above, the computing device 102a can be operated by a minting entity, as the first party P₁, and the computing device 104a is operated by a user (e.g., a purchaser of the cryptocurrency), as the second party P₂. The signal flow depicted in FIG. 2 represents a scenario, in which a shared key pair has already been generated as between the first party P₁ and the second party P₂, such that the firsty party P₁ and the second party P₂ each hold a respective private key share of a shared private key. For example, a DKG protocol can have been executed (202) to provide the first party P₁ with a first key set [k₁, Y] and the second party P₂ with a second key set [k₂, Y]. Here, k₁ is the private key share of the first party P₁ (which should remain secret to the first party P₁), k₂ is the private key share of the second party P₂ (which should remain secret to the second party P₂), and Y is the shared public key (which can be known by all parties). Further, the exeution of the DKG protocol results in a verification token v_{DKG}, for which each party can determined a respective verification token share, as described in further detial herein.

In the example of FIG. 2, it can be determined that a transaction is to be executed (e.g., transfer of cryptocurrency) that requires the first party P₁ and the second party P₂ to cooperatively sign a message m (e.g., Sign(m)→(m,σ)). In some examples, the first party P₁ generates and signs the message m. For example, the first party P₁ calculates a verification token share v₁ as:

$${F}_{{k}_{1}} ( bitstring ( Y ) \vert \vert bitstring ( Y ) ) G$$

The first party P₁ computes nonces d₁, e₁ as:

$${d}_{1} = {k}_{1} + {F}_{{k}_{1}} ( bitstring ( Y ) \vert \vert H ( m ) ) mod p$$

$${e}_{1} = {k}_{1} + {F}_{{k}_{1}} ( bitstring ( Y ) \vert \vert ¬ H ( m ) ) mod p$$

Here, Fₖ_{₁}, is a BH-PRF of the first party P₁. The first party P₁ computes nonces D₁, E₁ as:

$${D}_{1} = {d}_{1} G$$

$${E}_{1} = {e}_{1} G$$

The first party P₁ generates and sends (206) a message M₁, which includes a tuple (m, v₁, D₁, E₁), to the second party P₂. In some examples, components of the tuple are part of a first partial signature of the first party P₁ that is to be used to collectively sign.

In response to receiving the message M₁ (the first partial signature of the first party P₁), the second party P₂ executes verifications and computations (208). In some examples, the second party P₂ calculates a verification token share v₂ as:

$${F}_{{k}_{2}} ( bitstring ( Y ) \vert \vert ¬ bitstring ( Y ) ) G$$

Here, Fₖ_{₂} is a BH-PRF of the second party P₂. As such, the second party P₂ can calculate the verification token v as:

$$ϑ = {ϑ}_{1} + {ϑ}_{2}$$

That is, the verification token v is provided as the sum of the verification token share v₁ (Fₖ_{₁}(bitstring(Y)|bitstring(Y)) G, calculated by the first party P₁) and the verification token share v₂ (Fₖ_{₂} (bitstring (Y)∥-bitstring (Y)) G, calculated by the second party P₂). The second party P₂ verifies that:

$${D}_{1} - {K}_{1} + {F}_{{k}_{2}} ( bitstring ( Y ) \vert \vert ¬ H ( m ) ) G = ϑ = {ϑ}_{D K G}$$

and that:

$${E}_{1} - {K}_{1} + {F}_{{k}_{2}} ( bitstring ( Y ) \vert \vert H ( m ) ) G = ϑ = {ϑ}_{D K G}$$

If the second party P₂ determines that:

$${D}_{1} - {K}_{1} + {F}_{{k}_{2}} ( bitstring ( Y ) ‖ ¬ H ( m ) ) G = ϑ \neq {ϑ}_{D K G}$$

and/or that:

$${E}_{1} - {K}_{1} + {F}_{{k}_{2}} ( bitstring ( Y ) ‖ H ( m ) ) G = ϑ \neq {ϑ}_{D K G}$$

the second party P₂ can abort the transaction. Otherwise, the second party P₂ can respond to the first party P₁ to continue towards the final signature.

In some implementations, if verification is successful, the second party P₂ computes:

$${ρ}_{1} = {H}_{1} ( m + {D}_{1} + {E}_{1} )$$

$${ρ}_{2} = {H}_{1} ( m + {D}_{2} + {E}_{2} )$$

Here, the second party P₂ computes nonces d₂, e₂ as:

$${d}_{2} = {k}_{2} + {F}_{{k}_{2}} ( bitstring ( Y ) ‖ ¬ H ( m ) )$$

$${e}_{2} = {k}_{2} + {F}_{{k}_{2}} ( bitstring ( Y ) ‖ H ( m ) )$$

The second party P₂ computes nonces D₂, E₂ as:

$${D}_{2} = {d}_{2} G$$

$${E}_{2} = {e}_{2} G$$

The second party P₂ also computes:

$${R}_{1} = {D}_{1} + {E}_{1} {ρ}_{1}$$

$${R}_{2} = {D}_{2} + {E}_{2} {ρ}_{2}$$

$$R = {R}_{1} + {R}_{2}$$

$$c = {H}_{2} ( R , Y , m )$$

$${z}_{2} = {d}_{2} + ( {e}_{2} {ρ}_{2} ) + {k}_{2} c {λ}_{2}$$

The second party P₂ generates and sends (210) a message M₂ as a tuple (z₂, v₂, D₂, E₂). In some examples, components of the tuple are part of a second partial signature of the second party P₂ that is to be used to collectively sign.

In response to receiving the message M₂ (the second partial signature of the second party P₂), the first party P₁ executes verifications and computations (212). In some examples, the second party P₂ calculates a verification token share v₂ as:

$${D}_{2} - {K}_{2} + {F}_{{k}_{1}} ( bitstring ( Y ) ‖ ¬ H ( m ) ) G = ϑ = {ϑ}_{D K G}$$

and that:

$${E}_{2} - {K}_{2} + {F}_{{k}_{1}} ( bitstring ( Y ) ‖ H ( m ) ) G = ϑ = {ϑ}_{D K G}$$

If the first party P₁ determines that:

$${D}_{2} - {K}_{2} + {F}_{{k}_{1}} ( bitstring ( Y ) ‖ ¬ H ( m ) ) G = ϑ \neq {ϑ}_{D K G}$$

and/or that:

$${E}_{2} - {K}_{2} + {F}_{{k}_{1}} ( bitstring ( Y ) ‖ H ( m ) ) G = ϑ \neq {ϑ}_{D K G}$$

the first party P₁ can abort the transaction. Otherwise, the first party P₁ can continue towards generation of the final signature.

In some implementations, if verification is successful, the first party P₁ computes:

$${ρ}_{1} = {H}_{1} ( m + {D}_{1} + {E}_{1} )$$

$${ρ}_{2} = {H}_{1} ( m + {D}_{2} + {E}_{2} )$$

$${R}_{1} = {D}_{1} + {E}_{1} {ρ}_{1}$$

$${R}_{2} = {D}_{2} + {E}_{2} {ρ}_{2}$$

$$R = {R}_{1} + {R}_{2}$$

$$c = {H}_{2} ( R , Y , m )$$

$${z}_{1} = {d}_{1} + ( {e}_{1} {ρ}_{1} ) + {λ}_{1} {k}_{1} c$$

where K₂ is the public key share of the second party P₂ for the shared public key Y. The first party P₁ verifies that:

$${z}_{2} G = {R}_{2} + {K}_{2} c {λ}_{2}$$

If this verification fails, the first party P₁ can abort the transaction. Otherwise, the first party P₁ can continue by computing:

$$z = {z}_{1} + {z}_{2}$$

and generating the final signature as:

$$σ = ( R , z )$$

for publication with the message m.

In execution of the above operations, H₁ and H₂ are (cryptographic) hash functions. Here, the separate hash functions can be derived from the same family (e.g., as the hash function H) by using different salts. This ensures domain separation, which provides for additional security, because hash functions are deterministic. Further, in execution of the above operations, λ₁ and λ₂ represent a Lagrange coefficient of k₁ of the first party P₁ and of k₂ of the second party P₂, respectively. In the example context of the present disclosure, where there are only two parties, λ₁=λ₂=1 (i.e., the private key k is just the summation of k₁ and k₂. However, in other settings, Shamir secret sharing must be used, which results in different λᵢ values for different parties Pᵢ.

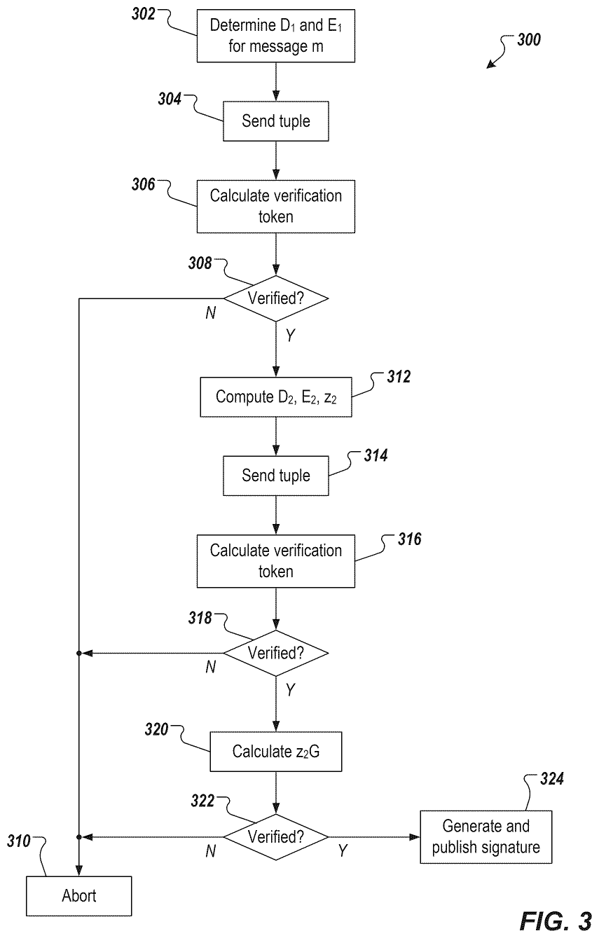

FIG. 3 depicts a flowchart of an example process 300 that can be executed in accordance with implementations of the present disclosure. In some examples, the example process 300 is provided using one or more computer-executable programs executed by one or more computing devices.

A first set of nonce values is determined for a message (302). For example, and as described in detail herein, a first party P₁ generates a first set of nonce values D₁, E₁ for a message m. A tuple is sent (304). For example, and as described in detail herein, the first party P₁ sends a tuple (m, v₁, D₁, E₁) to a second party P₂. A verification token is calculated (306) and it is determined whether verified (308). For example, and as described in detail herein, the second party P₂ calculates v₂ and v based on v₁ and v₂. In some examples, the second party P₂ compares v to v_{DKG} to determine whether the information provided from the first party P₁ is verified (i.e., can be trusted). If v≠v_{DKG}, the information is not verified and the transaction is aborted (310).

If v=v_{DKG}, the information is verified and a second set of nonce values is determined (312) and a tuple is sent (314). For example, and as described in detail herein, the second party P₂ generates a second set of nonce values D₂, E₂ for the message m and calculates z₂, and sends a tuple (z₂, D₂, E₂) to the first party P₁. A verification token is calculated (316) and it is determined whether verified (318). For example, and as described in detail herein, the first party P₁ calculates v based on v₁ and v₂. In some examples, the first party P₁ compares 2 to v_{DKG} to determine whether the information provided from the second party P₂ is verified (i.e., can be trusted). If v≠v_{DKG}, the information is not verified and the transaction is aborted (310).

If v=v_{DKG}, the information is verified and a verification parameter is calculated (320) and it is determined whether the verification parameter is verified (322). For example, and as described in detail herein, the first party P₁ calculates z₂G and determines whether z₂G is equal to R₂+K₂cλ₂. If z₂G is not equal to R₂+K₂cλ₂, the transaction is aborted (310). If z₂G is equal to R₂+K₂cλ₂, a signature for the message m is determined and is published with the message m (324). For example, and as described in further detail herein, the first party P₁ determines z (e.g., z=z₁+z₂) and calculates the signature (combined signature of the first party P₁ and the second party P₂) as σ= (R, z). In some examples, the first party P₁ publishes the message m with the signature σ. By way of non-limiting example, the message m can be associated with execution of a cryptocurrency transaction and can be published to one or more components (e.g., smart contracts) with the signature σ, which can be verified (e.g., by the smart contract(s)) before the transaction is executed.

Implementations of the present disclosure address technical challenges and provides technical solutions for security and efficiency in cryptographic networks (e.g., cryptocurrency networks). With respect to security, the following features of implementations of the present disclosure can be considered. A feature is that the nonces (eᵢ, dᵢ)_{i∈{1,2}} are generated deterministically using the respective parties' private key shares (e.g., k₁, k₂), the message m, and the public key Y using the respective KH-PRFs (e.g., Fₖ_{₁}, Fₖ_{₂}). As such, the partial commitments are dependent on the message m, and are not generated a priori. Another feature is that each party can verify that the other party has correctly computed its share of the nonce R, by checking the shared verification token v=F′ₖ_{₁}_{⊕k}_{₂} (bitstring (Y)∥1) G, ensuring no party can deviate from the protocol without detection. Consequently, the success of a (probabilistic) polynomial time adversary [symbol] in performing an attack depends on breaking the security of the underlying KH-PRFs, which are used to generate the deterministic nonces. If [symbol] can distinguish the outputs of the KH_PRFs and BH-PRFs from random strings, only then can [symbol] derive any non-negligible information about the private key shares. Therefore, it follows that implementations of the present disclosure are secure under the following assumptions: the Schnorr signature scheme satisfies Existential Unforgeability under Chosen Message Attacks in the random oracle model; and the homomorphic PRF families used to generate the nonces are secure/pseudorandom.

With respect to efficiency, efficieny of implementations of the present disclosure can be measured against an estimation of the most-efficient known protocol (reference protocol) for our target setting (i.e., 2-out-of-n signing). The reference solution can be analyzed at a relatively high-level, where each round involves multiple PRF evaluations, and exponentiations in [symbol] , which can take thousands of cycles. This is particularly the case with strong security assumptions (e.g., Strong RSA) and VOLE-based consistency checks, which introduce significant additional overhead in terms of consumption of technical resources.

A rough estimate puts the added overhead of the reference protocol compared to a standard threshold Schnorr schema at 4-5 times the consumption of technical resources. In comparison, and as described herein, implementations of the present disclosure use only single evaluation of a KH-PRF from each party. The KH-PRFs are computationally efficient and their computational overhead is only 4-10 times that of AES. This results in an estimate of the added overhead of the nonce generation and verification of the present disclosure at approximately 2 times that of the standard threshold Schnorr schema, which is more efficient than the reference protocol.

Implementations of the present disclosure further provide technical efficiencies over prior approaches. For example, some approaches, such as FROST, implement a pre-processing protocol to generate multiple sets of single-use nonces for each party, to record the multiple sets of single-use nonces in a list, and to publish and store the list in some location. This is all prior to execution of any signing protocol. As such, this is an a priori approach that requires consumption of technical resources. For example, processing is expended to generate the list and memory is consumed to store the list. Further, because the nonces of prior approaches are single-use, technical resources are expended to maintain the list as nonces are used.

Further, single-use nonces of prior approaches present additional disadvantages that implementations of the present disclosure overcome. For example, approaches implementing single-use nonces must be stateful to account for potential that a state of a party can be lost (e.g., a computing device of the party goes offline during signing). Implementations of the present disclosure provide an approach that is stateless, because the nonces, being deterministic based on the message m, can be regenerated, when the party comes back online.

Additionally, decentralized applications (dApps) (e.g., user wallets in cryptocurrency networks) can require support for deterministic threshold Schnorr and can mandate or prefer deterministic EdDSA. Because deterministic EdDSA is computationally inefficient, deterministic threshold Schnorr is preferred. However, as discussed herein, without implementations of the present disclosure, it is infeasible to securely and efficiently realize stateless threshold deterministic Schnorr using traditional approaches.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for secure execution of transactions between computing devices in cryptographic networks, comprising:
receiving, by a second computing device and from a first computing device, a first set of nonce values, each nonce value in the first set of nonce values being generated using a first bi-homomorphic pseudo-random function (BH-PRF) of the first computing device and being deterministic with respect to a message;
transmitting, by the second computing device and to the first computing device, a second set of nonce values, each nonce value in the second set of nonce values being generated using a second BH-PRF of the second computing device and being deterministic with respect to the message; and
executing, by the second computing device, at least part of a threshold signature scheme (TSS) in response to:
verifying, by the second computing device, correctness of a verification token based on the first set of nonce values and the second BH-PRF, and
correctness of the verification token being verified by the first computing device based on the second set of nonce values and the first BH-PRF.

2. The computer-implemented method of claim 1, wherein each nonce value in the first set of nonce values is further generated using a first private key share of the first computing device, and each nonce value in the second set of nonce values is further generated using a second private key share of the second computing device.

3. The computer-implemented method of claim 2, wherein the first private key share and the second private key share are each used in the TSS to generate respective partial signatures for the message.

4. The computer-implemented method of claim 2, wherein the first private key share and the second private key share are each generated using a distributed key generation (DKG) protocol.

5. The computer-implemented method of claim 1, wherein each nonce value in the first set of nonce values and each nonce value in the second set of nonce values is further generated using a shared public key.

6. The computer-implemented method of claim 1, wherein each nonce value in the first set of nonce values and each nonce value in the second set of nonce values is further generated using a hash of the message.

7. The computer-implemented method of claim 1, wherein executing, by the second computing device, at least part of a TSS comprises generating a partial signature for the message and transmitting the partial signature to the first computing device.

8. The computer-implemented method of claim 7, wherein the first computing device generates an aggregate signature comprising the partial signature and at least one other partial signature.

9. The computer-implemented method of claim 1, wherein the first computing device is operated by a minting entity that mints a cryptocurrency.

10. The computer-implemented method of claim 1, wherein the second computing device is operated by a user that trades a cryptocurrency.

11. A non-transitory computer-readable storage medium coupled to one or more processors and having instructions stored thereon which, when executed by the one or more processors, cause the one or more processors to perform operations for secure execution of transactions between computing devices, the operations comprising:
receiving, by a second computing device and from a first computing device, a first set of nonce values, each nonce value in the first set of nonce values being generated using a first bi-homomorphic pseudo-random function (BH-PRF) of the first computing device and being deterministic with respect to a message;
transmitting, by the second computing device and to the first computing device, a second set of nonce values, each nonce value in the second set of nonce values being generated using a second BH-PRF of the second computing device and being deterministic with respect to the message; and
executing, by the second computing device, at least part of a threshold signature scheme (TSS) in response to:
verifying, by the second computing device, correctness of a verification token based on the first set of nonce values and the second BH-PRF, and
correctness of the verification token being verified by the first computing device based on the second set of nonce values and the first BH-PRF.

12. The non-transitory computer-readable storage medium of claim 11, wherein each nonce value in the first set of nonce values is further generated using a first private key share of the first computing device, and each nonce value in the second set of nonce values is further generated using a second private key share of the second computing device.

13. The non-transitory computer-readable storage medium of claim 12, wherein the first private key share and the second private key share are each used in the TSS to generate respective partial signatures for the message.

14. The non-transitory computer-readable storage medium of claim 12, wherein the first private key share and the second private key share are each generated using a distributed key generation (DKG) protocol.

15. The non-transitory computer-readable storage medium of claim 11, wherein each nonce value in the first set of nonce values and each nonce value in the second set of nonce values is further generated using a shared public key.

16. The non-transitory computer-readable storage medium of claim 11, wherein each nonce value in the first set of nonce values and each nonce value in the second set of nonce values is further generated using a hash of the message.

17. A system, comprising:
one or more processors; and
a non-transitory computer-readable storage device and having instructions stored thereon which, when executed by the computing device, cause the computing device to perform operations for secure execution of transactions between computing devices, the operations comprising:
receiving, by a second computing device and from a first computing device, a first set of nonce values, each nonce value in the first set of nonce values being generated using a first bi-homomorphic pseudo-random function (BH-PRF) of the first computing device and being deterministic with respect to a message;
transmitting, by the second computing device and to the first computing device, a second set of nonce values, each nonce value in the second set of nonce values being generated using a second BH-PRF of the second computing device and being deterministic with respect to the message; and
executing, by the second computing device, at least part of a threshold signature scheme (TSS) in response to:
verifying, by the second computing device, correctness of a verification token based on the first set of nonce values and the second BH-PRF, and
correctness of the verification token being verified by the first computing device based on the second set of nonce values and the first BH-PRF.

18. The system of claim 17, wherein each nonce value in the first set of nonce values is further generated using a first private key share of the first computing device, and each nonce value in the second set of nonce values is further generated using a second private key share of the second computing device.

19. The system of claim 17, wherein each nonce value in the first set of nonce values and each nonce value in the second set of nonce values is further generated using a shared public key.

20. The system of claim 17, wherein each nonce value in the first set of nonce values and each nonce value in the second set of nonce values is further generated using a hash of the message.
